(19) United States
(12) Patent Application Publication
(10) Pub. No.: US 2006/0161680 A1
(43) Pub. Date: Jul. 20, 2006

(54) Communications Interchange System

(75) Inventor: Miguel Balsevich, New York, NY (US)

Correspondence Address: Ted Sabety;SABETY & ASSOCIATES, 36th Floor, One Penn Plaza, New York, NY, 10119, US

(73) Assignee: GTV SOLUTIONS, INC., New York, NY (US)

(21) Appl. No.: 10/548,728

(22) PCT Filed: Mar. 8, 2004
(86) PCT No.: PCT/US04/06809

§ 371 Date: Sep. 9, 2005

Related U.S. Application Data
(60) Provisional application No. 60/453,634, filed on Mar. 11, 2003.

(51) Int. Cl. G06F 15/16

(52) U.S. Cl. 709/245; 709/227

(57) ABSTRACT

An extensible data communication protocol is described that operates between remote computers and a server computer on the same network, where the computers exchange data messages while the server manages addressing of the communication, so that applications running on the computers can communicate without reference to the underlying network addresses, but rather by means of virtual addressing based on some other label or indicia of identity, including the identity of the computer sending the data message and the identity of the intended recipient computer. Other improvements to data packet and network address management are also part of the invention are presented.

### BACKGROUND AND SUMMARY OF THE INVENTION

The present invention relates generally to data networks, typically packet switched networks like the Internet. Typical network communication requires that applications establish connections at specific numerical addresses corresponding to the topological location of the two computers that are communicating. The invention is a data communication protocol that includes protocols for an application running on one computer on the network to establish a connection with another computer on the network using the identity of the user of the destination computer or some similar indicia of identity, without the first computer requiring that the actual network address location used by the network protocol be used. In addition, this protocol can be used to establish remote inter-process communication between processes on remote computers where the remote systems invoke the communication using identity as an indicia of destination rather than network address location. This method is dynamic, so that as the topological location on the network of either computer changes, the protocol dynamically updates the mapping of the indicia to the actual network address of the destination. Other inventions that improve packet switching networks are presented, including dynamic time to live determination, dynamic address translation for peer to peer data transmission, invoking a communication channel for users of an application through a help menu, grouping permissions for access or status, presenting available users for communication grouped by a pre-determined criteria and using the network server to manage delivery of a file to a group of users.

### BRIEF DESCRIPTION OF THE DRAWINGS

FIG. 1: IM Network Schematic. This drawing demonstrates how the modules the comprise the IM Network functionality are connected.

FIG. 2: Example IM Network topology with the Server on the public network, for example, the Internet.

FIG. 3: Example IM Network topology with the Server on the private network.

FIG. 4: Sample graphical user interface for the network management record for a specific client on the IM Network.

### DETAILED DESCRIPTION OF THE PREFERRED EMBODIMENTS

Backgound.

This invention is directed toward communication of data between computers connected on a data network, typically the Internet, but the invention is applicable on any data network In the preferred embodiment, there are at least two computers, each attached to the network through an active network connection. On each computer runs a program, called the “Client.” The Clients exchange data across the network. Also attached to the network is a computer running another application called the “Server.” The Server communicates with the Clients in order to conduct the data communication between the at least two Clients as described below.

Typical communications across data communications networks are by use of packet switching, where the data is assembled into individual packets. Each packet has a header that contains a numerical address. In the case of the Internet, this is called the IP address. The physical locations of computers on the network are mapped to the IP address numbers. On the Internet, each publicly accessible source or destination has a unique IP address. Some of those locations are ports to private networks that have internal addresses that are unique within the private network, but not necessarily unique among all networks. Reference is made to Internet Standards and Protocols, Dilip C. Naik, Microsoft Press, 1998 and the Internet specifications set forth by the Internet Engineering Taskforce (IETF) http://www.ietf.org/, with regard to network protocols and addressing conventions.

IM Network.

The invention is intended to provide an extensible protocol that operates between the Clients and the Server so that applications running on the same computers that run the Clients can communicate without reference to the underlying IP addresses, but rather by means of virtual addressing based on some other label, and in cases where labels are not unique across the entire network, then by also using the identity of the Client sending the data message. The invention is referred to as an IM Network. The invention works as follows when Client A sends data to Client B:

Assume both Client A and Client B are activated. Upon activation, each Client possesses the IP address of the Server and communicates with the Server to indicate both their IP address and some indicia of their identity, for example, in terms of the identity of the user or identity of the computer they are operating on. This indication can be determined by the Server by examining the incoming activation message: the network protocol will provide the IP address while the message will contain the indicia of identity. The Server maintains a list of active clients, indicated by a table of such indicia and the corresponding IP address for such client. In the preferred embodiment, there is a unique list that corresponds to each unique Client or user of a Client. Client A assembles a message that is sent to the Server that indicates its intent to send a data message to Client B, identified not by IP address but by such other indicia. The Server returns the IP address of Client B to Client A. Client A assembles a message for Client B using the delivered IP address for Client B and presents the message to the applicable network protocol that uses IP addressing, for example, TCP/IP. The network protocol then delivers the message to Client B across the network. The practitioner of ordinary skill will recognize that the function of the Server can be replaced with a distributed architecture where the list of active clients and corresponding IP addresses are distributed across several servers or across all of the clients or where all of the lists are stored in their entirety on each Client computer. The underlying functionality will logically remain the same, so this description of the invention will be based on the architecture where a separate server computer is operating.

The practitioner of ordinary skill will recognize that the server list of Clients can include registered but inactive Clients, and that the indicia can include other data, for example, data indicating permission for a specific Client to communicate with another Client, permission for the Server to indicate to a Client the operating status of another Client, permissions applicable to other users, membership of a Client in at least one arbitrary group of Clients and the like. Likewise, the Client can present to its user the list of groups, permitted users, active users, inactive users and members of a group available to the Client. In addition, the communication between Client A and Client B, as described above can also be between Client A and all of the clients in a group.

In cases of group distribution, the server can be utilized to minimize redundant uses of bandwidth, as described below.

A number of communications applications can exploit this system. One example is a common form of inter-user text messaging called Instant Messaging, referred to herein as IM. In such a use, the user of Client A can initiate a message to the user of Client B without Client A initially possessing the IP address of Client B. Client B will instantly display the message that arrives from Client A. Likewise, the user of Client B can respond to the user of Client A by the same protocol. Practitioners of ordinary skill will recognize that once the message from Client A to Client B has been received, Client B can communicate directly with Client A, and vice versa using the IP address it has received in the message packet, making communication with the server optional. However, as explained below, in some cases such an approach may be less optimal in functionality than maintaining communication through the Server.

The practitioner of ordinary skill will recognize that the above architecture does not store messages when Client B is not activated, for example, if the user of Client B is offline. A modification to the system addresses this need, referred to as persistence. Persistence is achieved by routing the messages between Client A and Client B through the server. For example, instead of delivering the IP address of Client B to Client A and directly sending a message to Client B from Client A, Client A can assemble the message, including the indicia of identity of Client B, and deliver the message to the server. The server can then determine if Client B is activated or not. If not, then the server can store the messages in a queue. When Client B is activated, then the server will update its list of active Clients and deliver the messages for Client from the queue when it detects that Client B is activated.

Inter Process Communication using an IM Network for Localization of End-points and Negotiation of the Transport Layer.

Inter Process Communication (IPC) is an efficient mechanism for two processes to communicate between themselves. Typically, the processes either pass messages or share memory locations. It can be a communication between a local or remote process. IPC mechanisms are generally exclusive to the operating system for which they are designed. Reference to http://www.developer2.com/features/stories/33490.html is made for examples of IPC for the Windows operating system. For IPC between processes running on distinct remote computers on a network typically require a transport protocol layer that can operate with the network. The implementation of IPC varies between operating systems. Some operating systems do not have any sort of IPC function, while others only implement one method. Many operating systems allow remote process communication via TCP/IP or some other form of network communication. The IEEE created a standard for doing this in 1991 called RPC (Remote Procedure Call). Reference is made to http://www.opengroup.org/onlinepubs/9629399/toc.htm and http://www.opengroup.org/onlinepubs/9629399/chap6.htm#tagcjh_{—}11.

The invention makes possible IPC between remote computers without either machine possessing the IP address or network name of the other computer. This is accomplished by providing a communication protocol API (application programming interface) that is active when the Client program is running on a system. Assume Process A and Process B, running on machine A and machine B, respectively. Also assume that Client A and Client B is running on both machines, respectively. Communication between Processes A and B is conducted as follows:

Process A assembles a message in accordance with the API, which includes the indicia indicating that the destination is Client B and a local index identifying the source process A and the destination process, i.e. process B. The message is delivered by the operating system on machine A to Client A. Client A then forwards a message to the server that, as described above, results in the IP address of Client B being returned. Alternatively, as explained above, Client A can forward the message, including the indicia for Client B to the Server. Then, in the first case, Client A assembles a message packet containing the data delivered by Process A and presents it to the network protocol, which then delivers the data to Client B. When the message packet arrives at Client B, it receives the message, then disassembles the message to determine that it is an IPC and the destination process, that is, Process B.

At this point, Client B, using the API, signals to Process B the presence of data, and the data is delivered to Process B. The practitioner of ordinary skill will recognize that typical inter process communications on the same machine, that is, between Process A or B and Client A or B, respectively, is accomplished using the operating system capabilities.

The practitioner of ordinary skill will recognize that the system can be designed so that the server handles the delivery of the IPC message directly. In this case, the message from Process A to Process B is delivered to Client A using the API. The destination is indicated by the indicia corresponding to Client B and a reference to Process B. Client A passes the message to the server. The Server then determines the corresponding IP address for Client B and then assembles a message using that IP address. The message is presented to the network by the server and the network delivers the message to Client B. Client B examines the message, determines which process is Process B, and delivers the data to Process B using the API.

In either case, the use of the Client and Server APIs in order to establish remote inter-process communication referencing only the indicia of destination Clients or the indicia of the destination Clients combined with the indicia corresponding to the source Client (so as to indicate which list the Server will use to map the destination indicia to an IP or network address), rather than specific IP addressing, is referred to as the IM Network Although the indicia may not be unique across the entire global network, each list of indicia is itself referenced to which instance of Client it is relevant for. In the preferred embodiment, the user identification of “XYZ” can still be unique if one mapping entry appears in the user list for user A and a different mapping for user B. The uniqueness is established at the time of communication when the Server detects whether the Client for user A or user B is the source of the message.

An important distinction between RPC and the invention is that RPC requires that the address of the destination host be used, or at least a sufficient amount of the address so that where dynamic endpoint determination is used, it is local to that network. The invention, on the other hand, does not require that either the sending or receiving process use the address at all: the protocol permits IPC using the indicia corresponding to the instances of the client. In addition, the invention also abstracts the IPC-Client interface protocol from the media or protocols used to transport data. A network protocol based IPC, like RPC, would require that the process interact in conformity with the specific network protocol. By abstracting to the Client API, the process using the Invention's API does not need to know nor depend upon the media or underlying network protocol: It would work the same using a typical network layer, like TCP/IP, or when using a tunneling protocol through other methods, for example, SMTP or IRC. It is the Client that manages the network protocol requirements. By presenting the APIs to the application layer running on the same machine as the Client, the application does not interact with the network transport layer.

The IM Network and Server are used to localize and negotiate the link between both ends of the IPC link. This would occur when the Server completes the mapping or localization of the source and destination Clients and which IP addresses each should use to communicate with the other. When these addresses are delivered to the Clients, addressing necessary to directly send message packets from source Client to destination Client can be directly used by the Clients. In this way, the invention can utilize whatever network transport protocol is available to move the data. However, once a connection is established using the IM Network protocols, the protocol utilized to exchange data between the end points (the transport protocol), does not necessarily need to also be the IM Network protocol: once the actual IP addresses are determined by the communicating Clients, they can maintain the channel using any protocol decided upon while negotiating the link, such as IRC, SMTP, Shared Files, HTTP, FTP, SMS. Note that the transport protocol can even include direct file writing or other forms of message passing between processes, for example shared memory, where Reading/Writing from/to a file is the form of inter process exchange. Whatever the network transport layer protocols (and the protocol layers it relies on, including the hardware or media) is managed for the communicating processes by the Client and operating system.

An example of the advantage this system provides is where two remote processes must communicate, but the physical location of one of them on the network changes.

In this example, a system presenting security prices is to be continuously delivered to a remote computer that processes the prices and display information about them to the user. As the user moves the remote computer among different locations, for example, different wireless network access nodes, its IP address will change. However, by means of the Server, the IP address corresponding to that users' indicia will be updated continuously. This is achieved by the Client periodically polling the Server in the manner of activation. Alternatively, the Client can re-activate when it detects that the local network IP address has changed, or its network connection has been reestablished. When the process that sends the securities pricing data to the user sends a message to the users' computer by means of the invention, it invokes the API of the Client and identifies the destination by the indicia, without knowing the specific IP address or other topological location of the destination Client. By means of the methods and system presented above, the data message is automatically routed to the appropriate IP address automatically without the source process possessing the current IP address.

Likewise, the abstraction of the IPC system makes it possible for a process, executing on one type of machine, for example, a desktop computer, to communicate in the same way with processes on similar machines or with processes on dissimilar devices, for example, hand-held devices, including, for example, cell phones that use wireless network protocols where the desktop computer has no knowledge of the network protocols and where the source process has no specific knowledge of the type of device the destination process is running on. The reverse is also true, that is, the hand held device can communicate across its wireless network to an access point to the Internet or some other network, to a computer, without having to manage the addressing protocols.

Other advantages of the system include that the protocol between Processes A and B can use the inherent capabilities of the instant messaging system. For example, the message from Process A to Process B can be made subject to the indicated permissions for Client B. Also, Process A can communicate simultaneously with a group of Processes by means of the grouping of instances of the Client. Further, the server can act as a queue for IPC messages where the destination Client corresponding to the destination process is not active.

The IPC invention is also distinct from typical remote process communication modes layered on network protocols because it is active, not passive. For example, the scheme localizes and gathers information from our about other applications running on a machine. This is not possible using TCP or a simple network layer. For example, the Client running on machine A, operating in this mode, can be set to assemble an IPC message to another machine B when a certain condition is detected on machine A. This is useful for applications ranging from digital rights management to computer security or computer maintenance. An example is where a machine at log-in receives incorrect passwords: the error can be detected by the IPC Client and a message sent to another computer, indicated by indicia, not IP location. In addition, when a secure file of some kind is checked for decryption, or initiate decryption or other status, the IPC system can immediately deliver a message containing keys to the process that is decrypting the file. In a further example, if a computer system has an error, the IPC system can deliver the error to another location, for example, a system administrator.

The invention includes two families of components. First, the compile-time libraries that encapsulate the underlying operating system inter-process channel services and encode/decode packets passed from/to the Client and the Server application. These modules convert requests operating on the IM network abstraction layer to transport protocol packets. Second are the run-time Client or Server modules which respond to the IPC APIs, which in turn maps requests from the processes using the IPC-Client and converts them into a series of requests for the IM Network abstraction layer. Following are descriptions of the preferred embodiment:

Sample IPC Link Establishment.

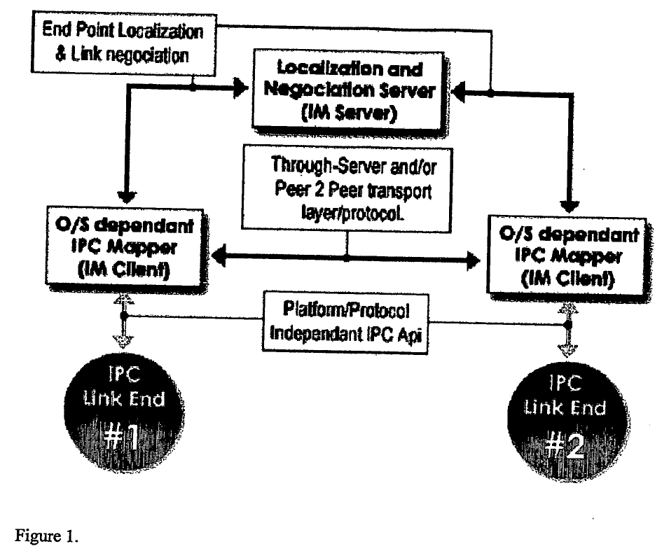

The preferred embodiment of the API is explained with reference to FIG. 1. Comments in the pseudo-code shall include reference to the drawing.

// This is an abstract sample of the code where certain sections
// (such as variable declarations, parameters and result checking)
// have been intentionally omitted for clarity.
// Instantiate the IPC class.
TSonorkIpc IPC;
// The first process, called IPC Link End#1, (1) initiates a connection with
//the IM Client IPC Mapper function, (2).
// Start and connect the IPC Link End to the IPC mapper (Client)

| | |
|---|---|
| IPC.Startup(SONORK_SERVICE_ID_DEMO_APP | // Unique application id |
| , configName | // Desired IPC mapper name |
| ); | |

// At this point, we're linked to the IPC Mapper
// but must register so that other IPC clients
// can locate us using the IM server.
//The IPC Mapper (2) registers the identifying indicia and network address
with //the Server (3).
IPC. RegisterService( SONORK_W32APP_SERVICE_HANDLER_CLIENT );
// Now our link point is visible to other IPC clients (5) and vice-versa.
// Use IPC methods to interact with them.
// Through the Server (3) the IPC Link (1) can interact with other
connected //IPC links, (5). For example, to open a channel, send data, or
initiate a //direct peer-to-peer channel, (6).
//
// Query other IPC end-points:
// This returns a list of possible remote end points, (5), which can be a
list of names or a list of names with corresponding addresses.
IPC. StartServiceQuery();
// Remote Client (4) can be ordered to respond to the query from Client (2).
// Answer to remote queries:
ServiceReplyData(name)
// Remote Client (4) can be ordered to reply to IPC (1) and list IPC links
(5) //available.
//Query another user for IPC end-points:
IPC. StartServiceQuery(name);
// IPC Link End (1) can send a data packet to remote IPC Link End (5).
// Send arbitrary data to an IPC end-point:
ipc.PokeServiceData(name);
// IPC Link End (1) can open a direct connection to the remote Link End (5)
// and use direct peer to peer communication (6).
// Establish a virtual circuit with an IPC end-point.
ipc. OpenServiceCircuitData(name);

Other Inventions Applicable to the IM Network or Other Data Networks Include:

1. Dynamically Determined Packet “time to live.”

Packet switching networks rely on retransmitting packets when no confirmation of the packet has been made. The sending computer running the network protocol must decide how long to wait for a confirmation before deciding to resend. If the time is too short, then there will too much redundant traffic. If the time is too long, then the apparent speed of the connection will be reduced substantially. The wait time is often determined dynamically. For example, under the TCP/IP protocol, the wait time is doubled from the previous unsuccessful packet. This can result in degradation of the connection even if only a few packets are lost. The invention determines the time to wait based on calculating a function of the previous response times from the network and the previous wait times for lost packets. This calculation is updated continuously. In this manner, a single lost packet will not appreciably increase the wait time, while a long stream of lost packets will. In addition, other measurements of the network conditions are included in the calculation of the wait time for a new packet. The preferred embodiment also accepts from the system administrator certain set parameters. In the preferred embodiment, the calculation of the wait time is as follows:

Fixed configuration values:

First, set configuration values are assigned to the variables when the link is first created. The notation below uses “˜” to indicate a typical range between the neighboring numbers. The symbol “←” is used to indicate an assignment of a value.

| // Multiplier and Divisor for calculating next retransmission time | |
|---|---|
| UdpDelayIndex | [symbol] 1.01 ˜ 20.00 |
| // Maximum retransmissions before failure | |
| UdpMaxRetryCount | [symbol] 1˜100 |
| // Minimum milliseconds before failure | |
| UdpMinRetryMsecs | [symbol] 1˜60,000 |
| // Minimum retransmission delay | |
| UdpMinAknMsecs | [symbol] 1˜60,000; < UdpMaxAknMsecs |
| // Maximum retransmission delay | |
| UdpMaxAknMsecs | [symbol] 1˜60,000; > UdpMinAknMsecs |
| // Extra retransmission delay to add for each fragment transmitted | |
| UdpMulAknMsecs | [symbol] 1˜512 |
| // Maximum UDP fragment size in octets | |
| UdpFragmentSize | [symbol] 64˜4096; recommended: 1024 |

Dynamic, per link, statistic values:

Link initialization values (Set when link is created).

msecsWaitedLastTime [symbol] UdpMaxAknMsecs/3 + UdpMinAknMsecs

| | |
|---|---|
| (a) | Start transmission of packet. |
| | numberOfFragments [symbol] (packetSize / UdpFragmentSize) + |
| | (packetSize % UdpFragmentSize)?1:0; |
| | extraMsecsToWait [symbol] UdpMulAknMsecs * numberOfFragments |
| | msecsToWaitBeforeResend [symbol] msecsWaitedLastTime |
| | Transmitting all fragments to the network and enter “wait for aknowledge” |
| | mode (b) |
| (b) | “Wait for acknowledge” |
| | Link waits until one acknowledgment arrives or (msecsToWaitBeforeResend + |
| | extraMsecsToWait) have elapsed. If one acknowledgment arrives before that |
| | period, process the acknowledgment (c), otherwise skip to acknowledgment |
| | timeout (d) |
| (c) | Process the aknowledgement |
| | An acknowledgment arrives before (msecsToWaitBeforeResend + |
| | extraMsecsToWait) |
| | If this is the first fragment being acknowledged and no retransmissions |
| | have ocurred, update the link statistics based on the time between the |
| | transmission and the acknowledgment of the fragment. |
| | roundTripMsecs [symbol] msecs since transmission of the acknowledged |
| | fragment. |
| | if roundTripMsecs < msecsToWaitBeforeResend |
| | msecsToWaitBeforeResend [symbol] (msecsToWaitBeforeResend + |
| | roundTripMsecs)/2 |
| | else |
| | msecsToWaitBeforeResend [symbol] roundTripMsecs |
| | if the number of distinct acknowledged fragments is numberOfFragments |
| | Packet has been successfully transmitted and we |
| | proceed to update the link statistics (e) |
| | else |
| | enter “Wait for acknowledge” mode (b) |
| (d) | Acknowledgment timeout |
| | No acknowledgment arrives within allowed period. When |
| | (msecsToWaitBeforeResend + extraMsecsToWait) elapse and no |
| | acknowledgements are received, new delay values are calculated as |
| | follows: |
| | msecsToWaitBeforeResend [symbol] (msecsToWaitBeforeResend * UdpDelayIndex ) |
| | extraMsecsToWait [symbol] UdpMulAknMsecs * (numberOfFragments not anknowledged) |
| | Proceed to retransmit all non-acknowledged fragments and then enter |
| | “Wait for acknowledge” mode (b) |

(e) Packet successfully transmitted. Update the only value we use for next
packet.

msecsWaitedLastTime [symbol] msecsToWaitBeforeResend

The practitioner of ordinary skill will recognize that this method will work on any packet switching network that retransmits packets when no confirmation is received by a specific time.

2. Dynamic Address Translation for Peer to Peer Transmission.

In certain cases, the location of a Client on the IM Network may be behind a network firewall, or otherwise possessing a private network address invisible to the public network. When the Client behind the firewall is activated, it communicates with the public server for access to the IM Network. At this time, the server detects what kind of address translation is necessary for another Client to directly send a message packet from the second Client to the first, as in a peer-to-peer connection.

The Server delivers to the Client at least two IP addresses: one representing location of the Server from standpoint of the Client and the other the location of the Client from standpoint of the Server, which may be different due to use of a router in the middle. The Client checks to see if both IP addresses are the same, if so then the peer to peer connection is established entirely on the private network, and the IP addresses of the Clients are adjusted accordingly. If not, then the private IP addresses may be the same or different. If different, then it is communication between two separate LANs on the public network. For these messages, the Server delivers to the Client which port is to be used at the destination network The Server holds a list for each host, indicating which router port does the network address mapping. An entry for each Client is determined upon activation of the Client. Alternatively, when a private network administrator configures the router, they can send this information to the Server. Once set up in this manner, when the Client sends a message out of the private network, it gets the proper port for the destination host from the Server. The Server can also store the Server mappings populated automatically from known configurations of typical commercial routers on the network. In addition, the mapping for well known commercial routers can be included with each instance of the Client.

The disclosure of the preferred embodiment shall use the following terms, as generally defined below:

UTS address: This is the network address of the messenger or service, as seen by the messenger/service itself. It is, in other words, the “local host”

HOST address: This is the network address of the connected messenger, as seen by the Server.

Network ID: An arbitrary number assigned by the network administrator to each set of computers. Mappings are rules that define how one set of computers must connect to another one. The mappings can be passed to the Client when it connects to the Server.

The operation of the invention is as follows: Normally, both UTS and HOST addresses for a Client are the same, but in private/extranet environments, there are cases where they differ. For example, if Client “A”, in the case of a machine addressed as 10.1.1.1, connecting to the IM Network Server using a SOCKS server located at 200.1.1.1, then the UTS address of “A” will be 10.1.1.1, but the Server will detect the Client as 200.1.1.1 because the SOCKS server is establishing the connection on behalf of the client. Thus, the UTS address is 10.1.1.1 and the HOST address is 200.1.1.1

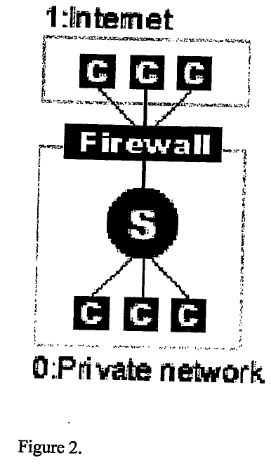

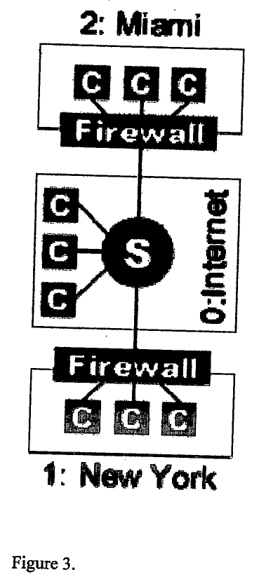

This will also happen if the Client is using network address translation (NAI): The Server will consider the address of the Client as the address of the machine or device that is running the NAT agent function. The network administrator must assign an arbitrary network ID, between 0 and 250 to each set of computers residing on the same private network. A set should enclose users in a same network. There are two topologies of the IM Network presented in FIGS. 2 and 3. In the first, the Server is located inside a private network, for example, behind a firewall. In the second, the Server is located on a public network, like the Internet. In both cases, there are users, whose Clients are located both behind the firewall or on the public network. The operation of each case is explained below:

Referring to FIG. 2, the IM Server (S) runs in a private network, behind a firewall that maps ports, and users (C) from both the Internet and the private network connect to the IM Server, (S). The administrator assigns the network ID, either 0 or 1 in this case, to the users connecting from the Internet and another one to the users connecting from within the private local area network (LAN). The private network users, indicated by (ID 0) don't need mappings to connect to the outside users because the Internet users (C) have a valid public AP address. The private users do not need mappings for the other private members of the LAN because they may be accessed using the private network IPs. However, the Internet users (ID 1) do need mappings because both the UTS and HOST addresses of users in the LAN are private non-outable IPs.

Referring now to FIG. 3, the IM Server runs with a valid IP address on the Internet. Users connect from Internet (ID 0) and from two private networks: New York (ID 1) and Miami (ID 2). The network administrator would use mappings to tell the Client that users in network ID 1 and network ID 2 should be accessed using the HOST address instead of the UTS address. Of course, the HOST address will work only if the firewalls are configured to accept incoming connections and map them to each one of the client machines. There is no need to map network ID 0 because all users on the Internet have valid IP addresses.

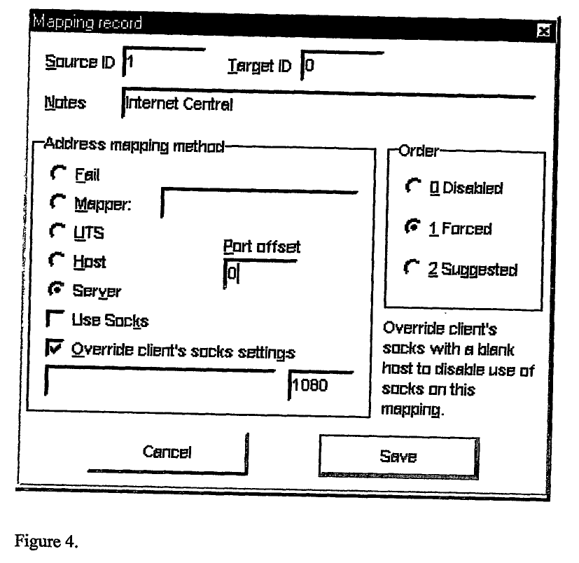

Each Client has a data record, or records where the Client stores parameters that determine which method of address resolution is appropriate based on the location of the Client. Referring now to FIG. 4, the network addressing input screen, applicable for operating the invention as described is presented. The input screen displays the content of a data record listing the addressing parameters and the manner of resolving network translations for both transmission out of and receipt in to a Client. The record tells the Client how to connect from an address with Network ID=“Source ID” to an address with Network ID=“Target ID”. This record is not symmetric: It is not used by “Target ID” to connect back to “Source ID”. Thus, for each Client, there is a record that indicates how to address to the IM Network. The following table lists each entry in the record under what conditions the entry is set to Boolean “true” or “false.”

| | |
|---|---|
| Disabled | Client does not use this record |
| Forced | Client should always use this record. (default) |
| Suggested | Client should use this record if it cannot safely determine the target address. |

Method

| | |
|---|---|
| Fail | Connection is not possible: Client should not try to connect. |
| Mapper | Client should try to connect to the specified address. |
| UTS | Client should use the target's UTS address. |
| Host | Client should use the target's Host address. |
| Server | Client should use the IM Network Server's address. |
| Port offset | When connecting, Client should add “Port offset” to the target's UTS |
| | port. For example: If the target messenger has been configured to use |
| | ports 100˜200 for UTS, and the firewall is mapping ports 1100˜1200 |
| | for that target, the Port Offset should be 1000. |
| Use Socks | The client must connect using SOCKS. If “Override” is not set, the |
| | client will use the Socks settings specified in its network |
| | configuration panel. If none has been configured, the connection will |
| | fail. |
| Override | The client's SOCKS settings must be overridden. If “Use Socks” is |
| | not checked, the client will not use SOCKS to connect, even if its |
| | network configuration specifies one. |

Referring now to FIGS. 2 and 3, the appropriate settings and operation of the address mapping will be explained for both possible topologies of the IM Network. In previous FIG. 2, the network administrator will set the entries in the record as follows:

Source: 1, Target: 0, Order: Forced, Method: Server

In this way all Internet users (ID 1) will connect to the private network users using the same address they have used to connect to the server.

In FIG. 3, the network administrator will set the entries in the record as follows:

Source: 0, Target: 1, Order: Forced, Method: Host

Source: 1, Target: 2, Order: Forced, Method: Host

Source: 2, Target: 1, Order: Forced, Method: Host

In this case, all attempts to connect to networks 1 and 2 are made using the Host address and not UTS. By using the Host address in these cases, the Server uses the address that it receives from the Clients when activating, which in this case is the address of the firewall the Client is routed through, in each case.

In cases where a Client is moving from location to location, as, for example, where the Client is a wireless device, the setting for the network mapping record may be seen as “default” values that are tried first, but then, other methods tried automatically until an appropriate connection with the Server is established. In this case, the record is modified dynamically by the Client and Server interaction as the Client moves from location to location.

3. Meta-Tag Activated IM Client

Another aspect of the invention has to do with the display of HTML pages. The Client can cause an instance of an Internet browser to be launched. The HTML data fetched by the browser from a website can be parsed by the Client at the same time as it is delivered to the browser for rendering. The parser in the Client will detect non-displayed data, called meta-tags, present in the HAML. The detected meta-tags can be one of a set of pre-determined text strings or other characters that correspond to specific commands to be executed by the Client. The set of pre-determined commands is a type of scripting language, which is interpreted by the Client. In addition, other data can be embedded in the meta-tags. When the Client encounters a meta-tag which is a command, it then executes the command, and in the case of a series of meta-tags, it will execute them in order. In the preferred embodiment, the Client will initiate an IPC message to a remote process when it encounters a meta-tag for launching a connection. The indicia corresponding to the destination Client can be either embedded in the meta-tag itself, found in the HTML document elsewhere, supplied by the user, fetched from the Server, fetched from elsewhere on the website or fetched from a file on the computer itself.

4. IM Help.

The Client can be invoked by third party application to obtain help for a user running the Client and the application. In this embodiment, the IM Client is a feature available as a selectable entry in a pull down menu running on another application. Alternatively, the Client can be running and using IPC, detecting the operation of the application. In the preferred embodiment, the IM Client is a selection under the “Help” menu. When invoked, the Client launches and retrieves a list of users on the network using at that same moment, the same application, who are available for initiating a message exchange, for example, to ask a question about using the application itself. The Client displays this list so that the user seeking to communicate may request direct help from users listed on the list corresponding the application. In the preferred embodiment, each available user has a ranking or qualification associated allows the user seeking help to decide on who to contact first. This determination can also be dynamic by the Client referencing the application provider's website in order to receive the correct reference to all resources associated with that application. Alternatively, a private network administrator can determine the set of local private users that can be contacted by the Client to open a message communication. Further, the state of the application itself can be communicated across the Network to the established recipient in order that the recipient can acquire complete knowledge of the state of the machine running the Client.

5. Visibility Groups:

The invention has a further aspect of filtering access and visibility permissions associated with users of the IM Network. The invention can provide the user a state where the user can determine which other users can determine whether the user is active or inactive. This is done selectively so that, for example, all users but one will find the user “inactive” while one user will find the user “active and on line.” The point of novelty on this aspect of the invention is that the filter restriction can be set for an entire group, not just for one individual at a time. Thus, the user can indicate “invisible” for an entire group and “accessible” for a different group or subgroup of the group.

6. Tracker Rooms:

The invention has a further aspect with regard to the organization and presentation of available users. The user interface of the Client, and the information provided by the Server can be organized so that users are grouped by some kind of pre-determined criteria. In the preferred embodiment, a user can find a group whose indicia is “C++ Expert Room” in order to find an expert on the computer language C++. A service hosting the IM Server can decide whether to provide the functionality of users volunteering to join a group, or whether the group itself is pre-determined, as in commercial help desk contexts.

7. File Delivery Management.

The invention has a ether aspect with respect to automatically controlling redundant file transfers. Under some conditions, an Client may be instructed by the user to deliver a file to a group of users. If the message is replicated for all the users in the group, this may impair data transmission speeds or otherwise increase bandwidth workload. In order to alleviate this, the Server will determine if a message is using the same file for a number of different users. In that case, only one copy of the file is retained on the Server, and each destination Client is alerted to the message and the presence of the file. The file is only downloaded to each destination Client when requested by the destination user. In the preferred embodiment, the source Client sends the message to the Server with a single copy of the file plus the indicia of the group or the list of individual receivers. The Server will organize each message or each individual receiver, but retain only one copy of the file on the server.

Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The spirit and scope of the present invention are to be limited only by the terms of the appended claims.

What is claimed:

1. An apparatus for controlling the data communication between at least two computers, a first computer running a first client software and a second computer running a second client software where the at least two computers are connected to the apparatus through at least one data communication network that conforms to at least one data networking protocol comprising:
At least one table of indicia of identity stored in a data memory of the apparatus comprised of at least one entry that is comprised of the second computer's indicia, where for each at least one indicia there is a corresponding reference in the table to the corresponding network protocol address of the at least one second computer;
A program stored in the apparatus data memory that when executed, in response to a request data packet comprised of the indicia of identity of the second computer which is communicated to the apparatus over the data network from the first computer, determines the corresponding network address of the second computer using the table.

2. The apparatus of claim 1 where the indicia of identity and network protocol address of the second computer is determined by examination of an activation message received by the apparatus from the second computer.

3. The apparatus of claim 2 where the examination is a determination of the network protocol address indicated by the protocol as the source of the activation message.

4. The apparatus of claim 1 where the table is stored in a plurality of computers connected through the at least one data communication network.

5. The apparatus of claim 1 where each table entry further comprises characteristic data about the first and second computers from the group of: permission for the first computer to communicate with the second computer, status information about the second computer, membership of the second computer in a predetermined group of computers.

6. The apparatus of claim 1 where the selection of the at least one tables to be used for the determination is determined by one or both of the indicia of identity of the first computer and network protocol address of the first computer.

7. A computer system comprising:
A data communication network connection attached to a computer;
A client software running on the computer that manages the network connection protocol and permits a program running on the computer to interact with the client where the program can instruct the client the destination of data transmissions across the network by means of indicia of identity of the destination computer.

8. A method of operating a server attached to at least one data communication network that conforms to a networking protocol that further connects with a first computer and a second computer comprising:
Receiving a data packet from the first computer that is comprised of the indicia of identity of the second computer;
Determining the networking protocol address of the second computer;
Transmitting to the first computer a data packet comprised of the networking protocol address of the second computer.

9. The method of claim 8 further comprising determining the networking protocol address of the second computer by detecting a data packet transmitted to the server as a result of the second computer activating a client software.

10. The method of claim 8 where the determining step is comprised of looking up in a table that maps indicia of identity to network protocol addresses, where the table is updated as a result of an activation message from the at least one second computers.

11. A method of transmission of messages on at least one data communication network that conforms to a networking protocol that further connects with a first computer, a second computer and a server comprising:
Receiving message from a first computer, that is comprised of the network protocol address of the server as the destination and the indicia of identity of the second computer at a predetermined location in the message;
Determining the network protocol address of the second computer;
Modifying the message so that the destination is the network protocol address of the second computer;
Transmitting the modified message into the data communication network.

11. A computer readable medium comprised of code, that when executed by a computer, performs the methods of claims 1-10.

12. A method of interprocess communication between a first computer running a first process with a first process identifier and a second computer running a second process with a second process identifier, each connected to a server on a data communication network that conforms to a network protocol comprising:
Receiving through a programming interface from the first process the first process identifier and the indicia of identity of the second process;
Assembling in the data memory of the first computer a first message comprised of the indicia of identity of the second process and the first process identifier;
Transmitting the first message to the server;
Receiving a second message from the server comprised of the network protocol address of the second computer corresponding to the indicia of identity and the first process identifier;
Assembling a third message comprised of the network protocol address of the second computer and information to be delivered to the second process;
Transmitting the second message packet across the data communication network.

13. The method of claim 12 where the first message packet comprises the indicia of identity of the instance of the client code executing the method on the first computer and the determining step further comprising selecting the mapping of indicia of identity to network protocol address on the basis of the indicia of identity of the client code instance on the first computer.

14. The method of claim 12 where the method is executed by an instance of the client code on the first computer and the assembling step is the causal result of the detection by the client code of a pre-determined state on the first computer.

15. A method of interprocess communication between a first computer running a first process and a second computer running a second process, each connected to a server on a data communication network that conforms to a network protocol comprising:
Receiving from the first computer a first message comprised of the indicia of identity of the second computer and information to be delivered to the second process, the first message the result of the first process passing a request through a programming interface;
Determining the network protocol address of the second computer based on the indicia of identity in the first message;
Modifying the message so that the destination is the network protocol address of the second computer;
Transmitting the modified message into the data communication network.

16. The method of claim 15 where the first message further comprises the indicia of identity of the instance of the client code executing the method on the first computer and the determining step further comprising selecting the mapping of indicia of identity to network protocol address on the basis of the indicia of identity of the client code instance on the first computer.

17. A method of interprocess communication between a first computer running a first process with a first process identifier and a second computer running a second process with a second process identifier, each connected to a server on a data communication network that conforms to a network protocol comprising:
Receiving from the first computer a first message comprised of the indicia of identity of the second computer and the first process identifier, the first message the result of the first process passing a request through a programming interface;
Determining the network protocol address of the second computer based on the indicia of identity in the first message;
Transmitting to the first computer a response comprised of the network protocol address of the second computer and the first process identifier.

18. The method of claim 17 where the first message further comprises the indicia of identity of the instance of the client code executing the method on the first computer and the determining step further comprising selecting the mapping of indicia of identity to network protocol address on the basis of the indicia of identity of the client code instance on the first computer.

19. A computer readable medium comprised of code, that when executed by a computer, performs the methods of claims 12-18.

20. A packet switching network where each transmitted packet is composed of a sequence of fragments that are retransmitted upon expiration of a first pre-determined amount of time without an acknowledgement comprising:
Transmitting a fragment without waiting for acknowledgment of a prior transmission of a fragment;
Calculating a new first pre-determined amount of time using as input either of the following two values: at least one of the durations measured from a prior transmission of a fragment until a transmission acknowledgement for the prior transmitted fragment or the number of times during a second predetermined amount of time that a transmitted fragment had no acknowledgement.

21. A packet switching network where each transmitted packet is composed of a sequence of fragments that are retransmitted upon expiration of a first pre-determined amount of time without an acknowledgement comprising:
Transmitting a fragment without waiting for acknowledgment of a prior transmission of a fragment;
Setting a first pre-determined amount of time to wait to be a value substantially equal to the amount of time waited on a prior transmission plus a second pre-determined extra time period;
Waiting for an acknowledgement during the first pre-determined wait time;
At the expiration of the first pre-determined wait time without an acknowledgement, increasing the first pre-determined wait time;
At the acknowledgement before or upon expiration of the first pre-determined wait time, changing the first pre-determined wait time based on the length of time between the transmission and the acknowledgement and the amount of time waited on a prior transmission.

22. The method of claim 21 where the changing step is further comprised of:
Determining whether the first pre-determined length of time is less than the wait time on a prior transmission;
Decreasing the first pre-determined amount of time if the determination is true and increasing the first pre-determined amount of time if the determination is false.

23. A packet switching network where each transmitted packet is composed of a sequence of fragments that are retransmitted upon expiration of a first pre-determined amount of time without an acknowledgement comprising:
The step for recalculating the pre-determined time to wait such that the time is decreased if the acknowledgement arrives prior to the expiration of the pre-determined time and the time is increased if the expiration occurs without an acknowledgement.

24. A computer readable medium comprised of code, that when executed by a computer, performs the methods of claims 20-23.

25. A computer readable medium comprised of code, that when executed on a computer, causes the computer to parse a text page stored in memory containing at least one meta-tag, detect at least one pre-determined meta-tag and execute a command corresponding to the value of the pre-determined meta-tag.

26. A computer readable medium, comprised of code, that when executed on a computer, causes the computer to perform a method comprising:
Displaying in a window at least one icon, that when activated, causes a predetermined application corresponding to such icon to execute;
Displaying in a window a set of available participants, where the set of participants is determined by the type of predetermined application;
Displaying in at least one window where the participant can respond to queries initiated in at least one window by the user of the application.

27. A method of communication between a first computer running a first client and a second computer running a second client, each connected to a server on at least one data communication network that conforms to a network protocol comprising:
Receiving from the second computer at least two network protocol addresses, one representing the location of the server from the standpoint of the second computer and the second the location of the second computer from the standpoint of the server;
Determining a network protocol address of the second computer to be used by the first computer by examination of the relative values of the two addresses;
Transmitting to the first computer the determined network protocol address.

28. A method to determine the network protocol address to be used by a first computer directly communicating with a second computer connected on a data network comprised of at least one network protocol comprising:
Receiving from the first computer a UTS and HOST address for the first computer;
Receiving from the second computer a UTS and HOST address for the second computer;
Checking whether the UTS address of the second computer is public and if true, transmitting to the first computer either the UTS or the HOST address.

29. The method of claim 28 where the checking step comprises checking whether the UTS address is private, and if true, then
checking if the HOST address of the first computer and HOST address of the second computer are the same, and if true, returning the UTS address of the second computer.

30. The method of claim 29 further comprising checking if the status of the second computer permits access from a public network, and if true, returning to the first computer the UTS address of the second computer.

31. A method to determine the network protocol address to be used by a first computer directly communicating with a second computer connected on a data network comprised of at least one network protocol comprising:
The step of resolving whether the first computer should use the UTS or HOST address of the second computer,
Transmitting to the first computer the resolved address of the second computer.

32. A method of limiting access by at least one user of a communication network and permitting access by at least one user of at least one other user of the network comprising:
assigning at least one user to a first group where a first state is indicated when a user in the first group queries the other user for access;
assigning a different user to a second group where a second state is indicated when the second at least one user in the second group queries the other user for access.

33. In an instant messaging communication system, a method of grouping available recipients of a query by a user whereby the group of recipients are grouped according to some pre-determined criteria and the group is presented to the user as a destination for the query.

34. In an instant messaging communication system, a method of file delivery on a computer network with a server comprising:
receiving a message with a file, where such message includes a list of users who are to receive the file;
making a single copy of the file on the server;
assembling messages to each such recipient user with a reference to the file copy on the server;
sending to each recipient the assembled message.

35. A computer readable medium comprised of code, that when executes performs any of the methods of claims 27-34.
